(19) United States
(12) Patent Application Publication
(10) Pub. No.: US 2008/0210575 A1
(43) Pub. Date: Sep. 4, 2008

(54) OXYGEN SENSOR FOR DETECTING NOx CONTAINED IN ENGINE EXHAUST GAS AND METHOD OF EVALUATING THE RECEPTIVITY OF THE OXYGEN SENSOR TO NOx

(75) Inventors: Takahiko NONOGAKI, Ichinomiya-shi (JP); Kiyomi Kobayashi, Kuwana-shi (JP); Takehito Kimata, Kariya-shi (JP); Zhenzhou Su, Okazaki-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/039,096

(22) Filed: Feb. 28, 2008

(30) Foreign Application Priority Data
Mar. 1, 2007 (JP) 2007-052000

(51) Int. Cl. G01N 27/26

(52) U.S. Cl. 205/784; 204/429

(57) ABSTRACT

In an oxygen sensor for installation in the exhaust gas system of a vehicle for detecting a concentration of NOx in exhaust gas downstream from a catalytic converter, in which the exhaust gas is passed through a protective layer to an electrode disposed at one side of a solid electrolyte in a sensor element of the oxygen sensor, the protective layer is formed with a combination of values of thickness and porosity which provide improved sensitivity in detecting low levels of NOx in the exhaust gas.

### CROSS-REFERENCE TO RELATED APPLICATIONS

This application is based on and incorporates herein by reference Japanese Patent Application No. 2007-052000 filed on Mar. 1, 2007.

### BACKGROUND OF THE INVENTION

1. Field of Application

The present invention relates to an improved oxygen sensor for detecting NOx, i.e., nitrous oxide (NO), nitrous dioxide (NO₂), etc., in the exhaust gas of an internal combustion engine, with the oxygen sensor being used in a condition of being installed in the engine exhaust system, downstream from a catalytic converter which cleanses exhaust gas. The invention further relates to a method of evaluating the receptivity of the oxygen sensor to NOx.

2. Description of Related Art

In recent years, increasingly severe regulations have been imposed in various countries, concerning the levels of pollutants (in particular, NOx) that are permitted to be emitted in the exhaust gas from motor vehicles. It is therefore becoming necessary to provide oxygen sensors that are capable of detecting very low levels of NOx concentration in engine exhaust gas. Such an oxygen sensor is installed in the exhaust system of a motor vehicle at a location downstream from a catalytic converter, and serves to measure the concentration of any NOx that has not been removed from the exhaust gas by the catalytic converter. The measurement results obtained by the oxygen sensor may be used for example by an engine controller, e.g., engine ECU (electronic control unit), in feedback control for adjusting the air/fuel ratio supplied to the engine such as to maintain the residual NOx concentration close to zero.

Various devices may be installed in the exhaust system of an internal combustion engine, including an air/fuel sensor for measuring the concentration of the exhaust gas produced from the engine, a catalytic converter that is located downstream from the air/fuel sensor in the exhaust system and which removes pollutants including CO gas, CH₄ gas and NOx gas, etc., from the exhaust gas, and an oxygen sensor as described above. Adjustment of the engine air/fuel ratio by feedback control based on the detected level of residual NOx, as described above, is necessary due to the fact that there are limitations on the capability of a catalytic converter in removing pollutants from the exhaust gas. By applying such feedback control of the engine air/fuel ratio, the catalytic converter can be utilized as effectively as possible, within its limitations, to ensure that harmful pollutant gases will not be present in the exhaust system at locations downstream from the catalytic converter.

FIG. 10 conceptually illustrates the flow of engine exhaust gas through a prior art oxygen sensor, designated by reference numeral 92. The direction of flow of the exhaust gas is indicated by the arrow G. The gas sensor element 92 includes a solid electrolyte 921, and a measured gas side electrode 922 and a reference gas side electrode (the latter not shown in the drawing) that are disposed on opposing faces of the solid electrolyte 921. The gas sensor element 92 also includes a protective layer 923, which covers the measured gas side electrode 922 while allowing the exhaust gas to pass to the measured gas side electrode 922. Such a type of oxygen sensor is described for example in Japanese patent first publication No. 2000-121597, designated in the following as reference document 1.

With such a type of oxygen sensor, any small amount of NOx in the exhaust gas that passes into the protective layer 923 is detected by the measured gas side electrode 922. The measurement result (i.e., value of voltage that is developed between the measured gas side electrode and the reference gas side electrode) obtained by the oxygen sensor are supplied to the engine controller. If NOx is detected by the oxygen sensor under a condition in which lean exhaust gas is being cleansed by the catalytic converter, then this indicates that harmful gases including NOx are being passed out from the exhaust system due to the fact that the capability of the catalytic converter to cleanse lean exhaust gas is being exceeded. In that case, the engine controller applies control of the air/fuel ratio supplied to the engine, to modify the air/fuel ratio such as to bring the exhaust gas from the engine into a condition whereby it can be sufficiently cleansed by the catalytic converter.

However since the levels of NOx that flow downstream from the catalytic converter are extremely small, if the protective layer 923 does not have a high value of diffusion resistance, the NOx gas will flow through and out of the protective layer 923 without reacting with the measured gas side electrode 922 to a sufficient extent. Due to this it has been difficult to achieve a sufficiently high performance in detecting minute amounts of NOx in engine exhaust gas using prior art types of oxygen sensor, and there is a requirement for an improved oxygen sensor which would have a capability of detecting such minute amounts of NOx.

### SUMMARY OF THE INVENTION

It is an objective of the present invention to overcome the above problem, by providing an oxygen sensor capable of detecting minute amounts of NOx that is present in exhaust gas from an engine, at a location downstream from a catalytic converter in the exhaust system of the engine.

It is a further objective of the invention to provide a method of evaluating the receptivity of the oxygen sensor to NOx.

To achieve the above objectives, according to a first aspect, the invention provides an oxygen sensor designed for installation in the exhaust system of an internal combustion engine, downstream from a catalytic converter which cleanses exhaust gas produced from the internal combustion engine, with the oxygen sensor comprising a solid electrolyte which conducts oxygen ions, a measured gas side electrode and a reference gas side electrode respectively disposed at opposing faces of the solid electrolyte, and a protective layer which cover the measured gas side electrode (i.e., covers external areas of that electrode which are not in contact with the solid electrolyte) while allowing the measured gas to permeate to the measured gas side electrode. The oxygen sensor is characterized in that the protective layer is formed to have a thickness that is within a range between 270 μm and 500 μm. The sensor is further characterized in that the protective layer is configured to have a porosity that is within a range between 3% and 7%.

These values are specified since it has been found that if the thickness of the protective layer is made greater than approximately 500 μm or the porosity of the protective layer is made less than approximately 3%, then the diffusion resistance of the protective layer becomes excessively high. As a result, insufficient amounts of NOx permeate through the protective layer to the measured gas side electrode, so that satisfactory detection of small amounts of NOx in the exhaust gas cannot be achieved.

Conversely, if the thickness of the protective layer is made less than approximately 270 μm or the porosity of the protective layer is made greater than approximately 7%, then the diffusion resistance of the protective layer becomes excessively low. In that case, a small amount of NOx that flows into the protective layer will pass through and out of the protective layer excessively rapidly, without reacting with the measured gas side electrode to a sufficient degree. Hence in that case too, satisfactory detection of small amounts of NOx in the exhaust gas cannot be achieved.

However if the protective layer is formed to have a suitable thickness and a suitable porosity, NOx is enabled to penetrate the protective layer but will be hindered from quickly flowing out from the protective layer. Hence, a sufficient amount of NOx can be temporarily retained within the protective layer, ensuring that there will be time for the NOx to react with the measured gas side electrode, and hence sufficient time for the oxygen sensor to detect the level of NOx present in the exhaust gas.

The term “receptivity to NOx”, as applied herein to an oxygen sensor, is to be understood as signifying the extent to which the oxygen sensor achieves an optimum balance between ease of enabling NOx gas to flow into the sensor, to be subjected to detection, and temporary retention (trapping) of NOx to a sufficient degree for enabling effective detection. The effect of improved receptivity of an oxygen sensor to NOx is that improved sensitivity in detecting small amounts of NOx can be achieved.

From a second aspect, the oxygen sensor is preferably configured to have a value of boundary current that is within a range between 0.1 mA and 0.2 mA (with a predetermined fixed voltage applied between the measured gas side electrode and reference gas side electrode) while a gas having a concentration of NO substantially equal to 400 ppm is being supplied to the oxygen sensor.

It has been found that an oxygen sensor having such a value of boundary current has a protective layer with an appropriately high diffusion resistance, thereby ensuring that small amounts of NOx contained in exhaust gas are permitted to flow into the protective layer but will be temporarily retained, i.e., the oxygen sensor can have good receptivity to NOx. If the boundary current is less than 0.10 mA, then the oxygen sensor will have an excessively high diffusion resistance, so that NOx will not readily pass into the protective layer, whereas if the boundary current is greater than 0.20 mA then the diffusion resistance will be excessively low, so that NOx which enters the protective layer will not be retained for a sufficient duration to enable effective detection.

Preferably, the test gas having a concentration of NO substantially equal to 400 ppm is a mixture of N₂ and NO gases and is supplied to the sensor at a flow rate substantially equal to 40 liters/minute.

From another aspect, the invention provides a method of evaluating the NOx receptivity of various configurations of oxygen sensor. The method comprises:

supplying a test gas to the oxygen sensor, consisting of a mixture of a combustible gas (at a concentration of equal to or less than 1000 ppm) and NO gas, while successively varying the concentration of NO gas in the test gas,

measuring the respective values of output voltage that are produced by the oxygen sensor, corresponding to successive values of NO concentration, and detecting when the output voltage attains a predetermined voltage, and

evaluating the receptivity of the oxygen sensor to NOx, based on the concentration of NO at which the predetermined voltage is attained.

Considering a plurality of oxygen sensors whose output characteristics are respectively different (e.g., due to differences in porosity of the respective protective layers of the oxygen sensors, etc.), each oxygen sensor can be tested by supplying a test gas while successively varying the concentration of NO in the test gas, and noting the value of NO concentration at which a predetermined value of output voltage is produced from the oxygen sensor. The lower the concentration of NO for which the predetermined output voltage is produced, the better is the receptivity of the oxygen sensor to NOx.

Such evaluation is preferably performed by supplying the test gas to each oxygen sensor at a flow rate of more than 30 L/minute, in order to approximate to the operating conditions of an oxygen sensor that is installed in an actual engine exhaust system.

The NOx receptivity of various configurations of oxygen sensor can thereby be readily compared, enabling an oxygen sensor having improved NOx receptivity (and hence improved sensitivity in detecting low concentrations of NOx in exhaust gas) to be obtained.

### BRIEF DESCRIPTION OF THE DRAWINGS

FIG. 1 is a conceptual cross-sectional view for illustrating the flow of gas through a gas sensor element of a layer-configuration oxygen sensor according to a first embodiment of the invention;

FIG. 2 is a cross-sectional view of the gas sensor element taken at right angles to the axial direction of the gas sensor element of the first embodiment;

FIG. 3 is a cross-sectional view of the oxygen sensor of the first embodiment, taken along the axial direction of the sensor;

FIG. 4 shows an example of an internal combustion engine exhaust system incorporating an oxygen sensor;

FIG. 5 is a cross-sectional view of a cup-configuration oxygen sensor, as an alternative oxygen sensor of the first embodiment, taken along the axial direction of the sensor

FIG. 6 shows relationships between sensor output voltage and NOx concentration supplied to an oxygen sensor, for oxygen sensor specimens having respectively different characteristics;

FIG. 7 shows relationships between sensor output voltage and NOx concentration supplied to an oxygen sensor, for an oxygen sensor specimens prepared in accordance with the present invention and for a comparison oxygen sensor specimen, respectively;

FIG. 8 shows relationships between sensor output voltage and NOx concentration supplied to an oxygen sensor, for oxygen sensor specimens having respectively different values of thickness and porosity of a protective layer in a gas sensor element;

FIG. 9 shows relationships between sensor output voltage and NOx concentration supplied to an oxygen sensor, for oxygen sensor specimens which have respectively different values of boundary current; and

FIG. 10 is a conceptual cross-sectional view for illustrating the flow of gas through a gas sensor element of an example of a prior art oxygen sensor.

### DESCRIPTION OF PREFERRED EMBODIMENTS

### First Embodiment

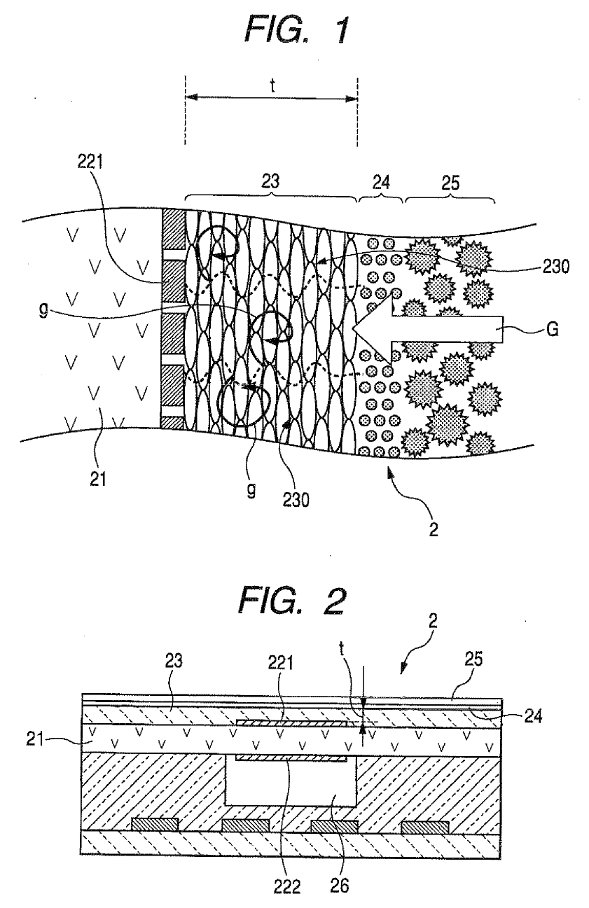

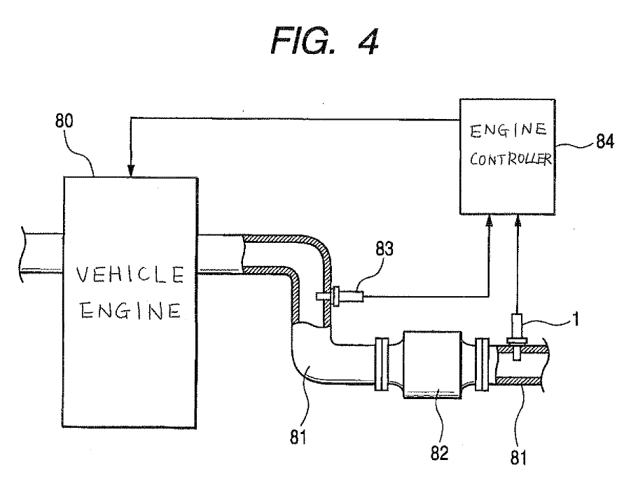

A first embodiment will be described referring to FIGS. 1 to 4. The embodiment is an oxygen sensor 1 which, as shown in FIG. 4, is disposed in an exhaust pipe 81 of a vehicle engine 80, downstream from a catalytic converter 82 which cleanses the exhaust gas from the vehicle engine 80. The configuration of a gas sensor element of the oxygen sensor 1 is conceptually illustrated in FIG. 1 and is shown in cross-sectional view in FIG. 2. The oxygen sensor 1 includes a solid electrolyte 21 having a measured gas side electrode 221 disposed on one side thereof and reference gas side electrode 222 disposed on the opposing side thereof. A protective layer 23 covers those portions of the measured gas side electrode 221 which are not adjacent to the solid electrolyte 21. A gas G which is being tested (i.e., for which the presence of NOx is being detected) passes into the protective layer 23, at the opposing side of the protective layer 23 from the measured gas side electrode 221. With this embodiment, the protective layer 23 has a thickness that is in the range 270˜500 μm, and has a porosity that is in the range 3%˜7%.

As shown in FIG. 4 the exhaust pipe 81 of the vehicle engine 80 is provided with an A/F (air-to-fuel) sensor 83 for measuring the exhaust gas concentration in the exhaust from the vehicle engine 80, in addition to the catalytic converter 82 (located downstream from the A/F sensor 83) and the oxygen sensor 1 which detects the concentration of any NOx that is present in the exhaust gas downstream from the catalytic converter 82.

The catalytic converter 82 cleanses the exhaust gas of the vehicle engine 80 by removing gaseous pollutants including CH₄, CO, NOx, etc.

However if the air/fuel ratio of the vehicle engine 80 is not appropriate, a sufficient degree of cleansing cannot be achieved by the catalytic converter 82, so that some pollutant gases (in particular, NOx) will flow downstream from the catalytic converter 82 and will be emitted to the atmosphere. The oxygen sensor 1 serves to detect whether this condition is occurring, and supplies the detection results to the engine controller 84. The engine controller 84 applies feedback control of the air/fuel ratio supplied to the vehicle engine 80, based on the detection results from the oxygen sensor 1, to reduce or eliminate the emission of residual NOx from the catalytic converter 82.

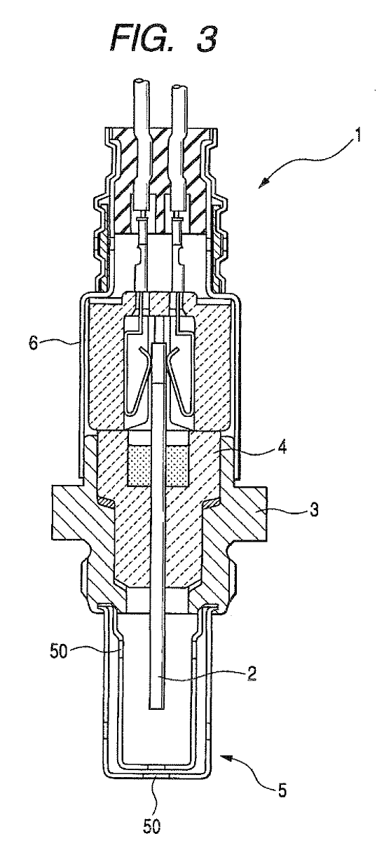

FIG. 3 is a cross-sectional view through the oxygen sensor 1, taken at right angles to the axial direction of the oxygen sensor 1. As shown, the oxygen sensor 1 includes a gas sensor element 2, a tubular housing 3, a measured gas side cover 5, and an atmosphere side cover 6. The gas sensor element 2 is of (planar) layer-configuration type, and is separated from the inner circumference of the tubular housing 3 by an element side insulator 4. The measured gas side cover 5 is disposed at one end of the tubular housing 3 (in FIG. 3, at the lower end), and the atmosphere side cover 6 is disposed at the opposite end (base end) of the gas sensor element 2. The interior of the measured gas side cover 5 is exposed to the gas (exhaust gas) that is to be tested to detect the presence of NOx, with that gas being referred to in general in the following as the measured gas. The interior side of the atmosphere side cover 6 is exposed to the surrounding (ambient atmospheric) air, so that this air passes into the atmosphere chamber 26 of the gas sensor element 2, as can be understood from FIG. 2.

The measured gas passes through the intake aperture 50 of the measured gas side cover 5 to reach the protective layer 23, via the trap layer 25 and the catalytic layer 24 (as indicated by the arrow G in FIG. 1). The catalytic layer 24 serves to collect certain pollutants from the exhaust gas. The measured gas then passes through small cavities 230 in the protective layer 23, to reach the measured gas side electrode 221.

When the measured gas changes from a rich to a lean condition, small amounts of NOx will tend to be contained in the measured gas for the reasons described hereinabove, and are detected by the oxygen sensor 1.

Also as described above, the protective layer 23 of this embodiment has a thickness in the range 270˜500 μm and a porosity in the range 3˜7%, since these have been found to be optimum ranges for achieving a high degree of sensitivity in detecting NOx in the measured gas. Specifically, with such values of thickness and porosity of the protective layer 23, once NOx gas has penetrated into the protective layer 23, it will be held trapped within the protective layer 23 (as indicated by the curved arrows g in FIG. 1) for a longer time than has been the case with prior art configurations of such a protective layer. Since NOx conveyed by the measured gas does not readily pass out from the protective layer 23 once it has entered, the NOx will react with the measured gas side electrode 221 to a sufficient extent, even if the concentration of NOx in the measured gas is extremely low.

It has thus been found that by setting appropriate values of thickness and porosity for the protective layer of an oxygen sensor as described above, it becomes possible for the sensor to reliably detect even very small amounts of NOx contained in a measured gas that is supplied to the oxygen sensor.

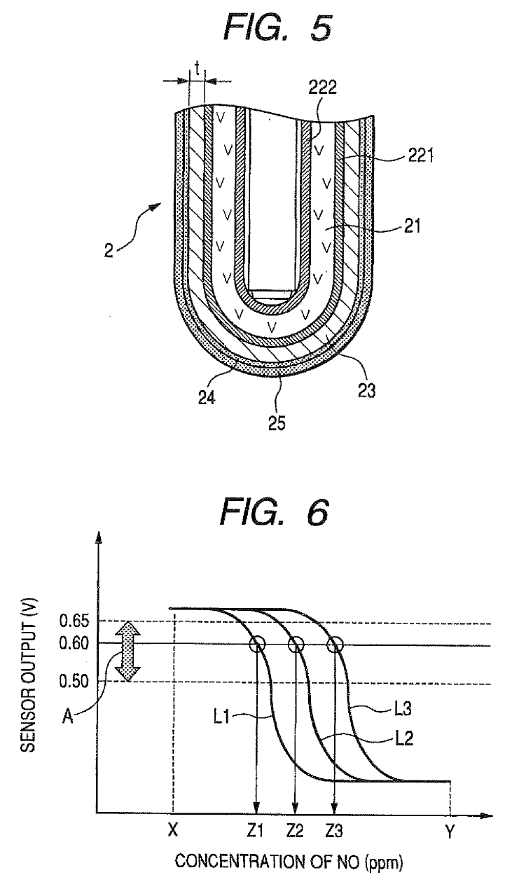

The first embodiment has been described above for the case of utilizing a flat layer-configuration gas sensor element 2 for the oxygen sensor. However the principles described are equally applicable to a cup-configuration gas sensor element 2 having the form shown in partial cross-sectional view in FIG. 5. In FIG. 5, components having corresponding functions to components shown in FIG. 3 are designated by identical reference numerals to those of FIG. 3.

### Second Embodiment

The invention further provides a method of evaluating the receptivity of the oxygen sensor to NOx, as will be described based on the following example, referring to FIG. 6. With this example, a test gas is formed of a mixture of N₂, H₂O, CO, CH₄, and NO, and is supplied to the oxygen sensor, with the concentration of NO in the test gas being successively increased from a value X to a value Y (X<Y) as shown in FIG. 6. As this is done, the output voltage from the oxygen sensor (developed between the measured gas side electrode and the reference gas side electrode) is measured, and the receptivity of the oxygen sensor to NOx is evaluated based on the value of NOx concentration in the test gas at which the output voltage of the oxygen sensor reaches a predetermined voltage.

This evaluation method is described in greater detail in the following, for the case in which a number of oxygen sensor specimens are to be respectively evaluated for the purpose of comparing their receptivities to NOx. Firstly a plurality of oxygen sensor specimens are prepared, having respectively different operating characteristics. It will be assumed that three oxygen sensor specimens are utilized in this example, respectively designated as specimen 1, specimen 2 and specimen 3.

The rate of flow of the test gas is set as 40 L/minute, with the rate of flow of the H₂O gas of the test gas being set as 5 L/minute and the temperature of the test gas fixed at 500° C. The respective concentrations of combustible gaseous constituents of the test gas (i.e., CO and CH₄) are fixed at 200 ppm and 50 ppm. When the concentration of NO in the test gas is altered, the concentration of N₂ in the test gas is altered correspondingly, such as to maintain the rate of flow of the test gas at the predetermined value. The respective concentrations of the test gas CO and CH₄ are thereby held fixed, as the NO concentration is varied.

The relationship between values of NO concentration and corresponding output voltage from the oxygen sensor is then measured, for each of the specimens 1 to 3. These relationships are exemplified by the characteristics designated as L1, L2 and L3 in FIG. 6, respectively corresponding to the specimens 1, 2 and 3. The receptivity to NOx is then evaluated for each specimen, based on the NO concentration at which the oxygen sensor output voltage becomes 0.6 V.

The lower the NO concentration at which the sensor output voltage becomes 0.6 V, the better is the receptivity of the oxygen sensor to NOx. It can thus be understood that with this example, the predetermined value of 0.6 V is used as an index for evaluating the receptivity of an oxygen sensor with respect to NOx. In the following, the NO concentration at which the output voltage produced by an oxygen sensor attains the predetermined value (with this example, 0.6 V) will be referred to as the NOx sensitivity of that sensor. For example if the predetermined output voltage is attained when the NO concentration is 400 ppm, then the NOx sensitivity will be designated as 400 ppm. Hence, the better is the receptivity of the oxygen sensor to NOx, the smaller will be the value of NOx sensitivity of the sensor (i.e., a smaller NOx sensitivity value signifies better detection sensitivity).

With the example of FIG. 6, the respective values of NO concentration at which the sensor output voltage becomes 0.6 V are Z1 (characteristic L1) for the specimen 1, Z2 (characteristic L2) for the specimen 2, and Z3 (characteristic L3) for the specimen 3. Thus with the terminology of the present invention, the respective values of NOx sensitivity of the oxygen sensors are Z1, Z2 and Z3. Since the specimen 1 achieves the 0.6 V output voltage when the NO concentration is the lowest of the three specimens, specimen 3 has the best NOx receptivity of the three specimens.

It can thus be understood that the invention provides a simple and effective method of evaluating the receptivity of oxygen sensors to NOx.

The range of oxygen sensor output voltage values from 0.5 V to 0.65 V, designated by the letter A in FIG. 6, is the typical range of values of output voltage (control voltage) produced from an oxygen sensor that is located downstream from a catalytic converter, i.e., a range of values of a voltage used in judging whether exhaust gas that is being measured is in a rich or a lean condition. Hence it would be possible to use some other predetermined value of sensor output voltage than 0.6 V, for evaluating the receptivity of an oxygen sensor to NOx, so long as the predetermined value is within the range 0.5˜0.65 V.

### Third Embodiment

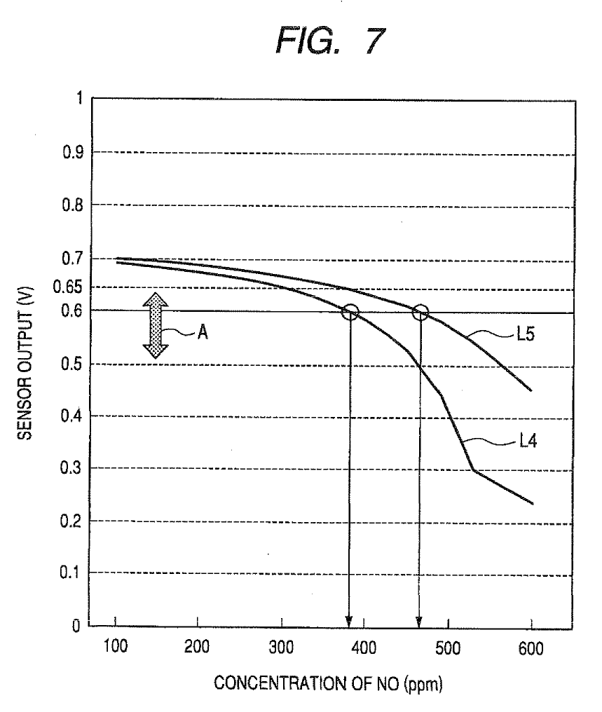

Another example of evaluating the receptivity of an oxygen sensor to NOx will be described referring to the FIG. 7. The evaluation is applied to an oxygen sensor having a protective layer with a thickness of 300 μm and a porosity of 5%, i.e., with these parameter values being within the ranges specified by the present invention. For comparison, an oxygen sensor having a protective layer with a thickness of 100 μm and a porosity of 8% was prepared.

A gas mixture having a similar constitution to that described for the second embodiment above, and having an NO concentration that was varied within the range 100 ppm to 600 ppm was supplied to each of the specimens. The receptivity of each oxygen sensor to NOx was evaluated using a predetermined sensor output voltage value of 0.6 V, as described for the second embodiment above.

The evaluation results are shown in FIG. 7, with the characteristics L4 and L5 respectively corresponding to the results obtained for the first specimen (prepared as specified by the present invention) and to the results obtained for the second specimen (comparison specimen). It was found that the NO concentration for which an output voltage of 0.6 V was obtained was 380 ppm for the specimen that was in accordance with the present invention. However in the case of the comparison specimen, an output voltage of 0.6 V was produced when the NO concentration become 460 ppm. Hence this shows that the specimen which was prepared in accordance with the present invention has a smaller NOx sensitivity value, i.e., has the better NOx receptivity of the two sensors.

### Fourth Embodiment

A total of 20 oxygen sensor specimens were prepared, each having a different combination of values of thickness and porosity of the protective layer, with the thickness values being selected from among 100 μm, 200 μm, 300 μm, 400 μm and 500 μm, and with the porosity values being selected from among 8%, 7%, 5%, and 3%. The NOx sensor value at which an output voltage of 0.6 V was produced was then measured for each of the specimens, as described for the second embodiment above.

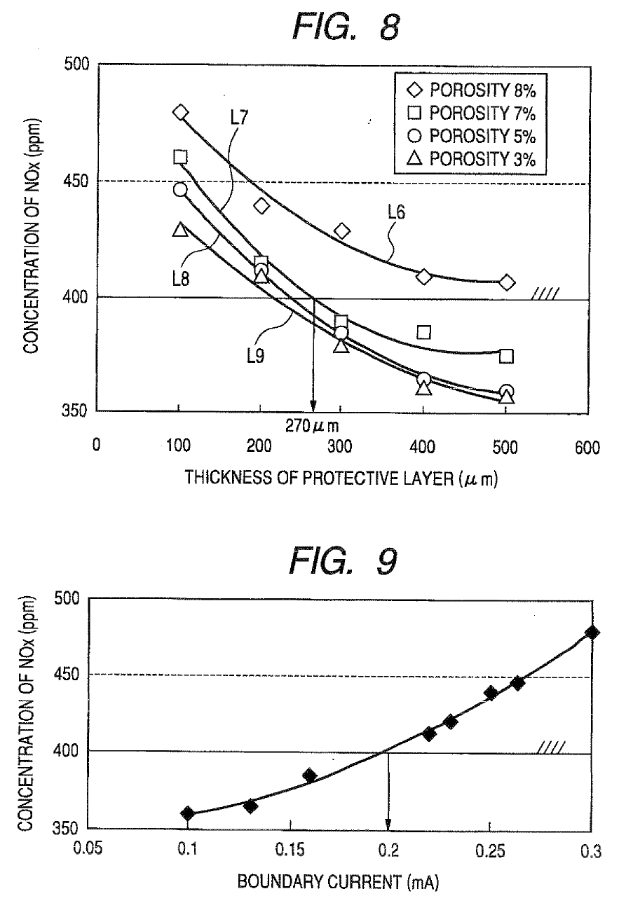

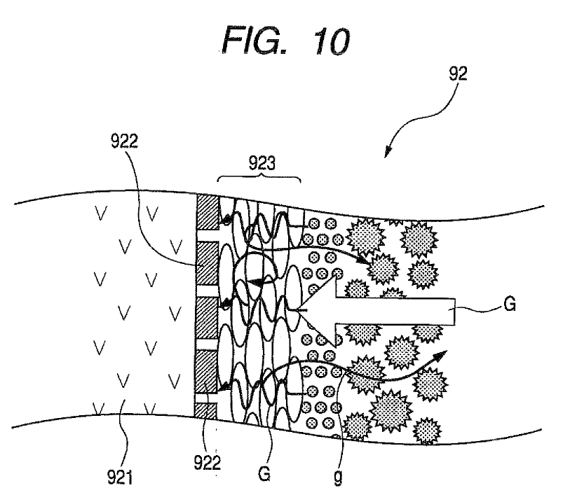

In FIG. 8, the diamond, square, circle and triangle symbols respectively designate results obtained for oxygen sensor specimens having porosity values of 8%, 7%, 5%, and 3% for the protective layer. The characteristic L6 in FIG. 8 shows the results of plotting values of NOx sensor versus protective layer thickness, for the case of a protective layer porosity of 8%. The characteristics L7, L8 and L9 similarly show the relationship between NOx sensitivity values and protective layer thickness, for the case of a protective layer porosity of 7%, 5%, and 3%, respectively.

As can be understood from FIG. 8, when an oxygen sensor has a protective layer thickness that is equal to or greater than 270 μm and a porosity that is equal to or less than 7%, the NOx sensitivity value becomes equal to or less than 400 ppm. Hence such an oxygen sensor is capable of detecting even minute levels of NOx gas. However FIG. 8 also shows that if the protective layer thickness is increased beyond 270 μm then it is not possible to achieve a NOx sensitivity value of equal to or less than 400 ppm. Specifically, with the porosity values used in this example, the NOx sensitivity value will always be higher than 400 ppm if the protective layer thickness is less than 270 μm.

With respect to the value of 400 ppm which is used as the standard value for evaluating NOx receptivity with this example, it should be noted that under current regulations concerning emission control, the emission control apparatus of a vehicle must be capable of detecting a concentration of NOx in exhaust gas that is as low as 400 ppm.

It can thus be understood from this example that if the porosity is equal to or less than 7% and the protective layer of an oxygen sensor has a thickness of equal to or greater than 270 μm, a sufficient degree of NOx sensitivity can be achieved.

### Fifth Embodiment

An example of investigating the relationship between NOx sensitivity (as defined hereinabove) of an oxygen sensor and boundary current values will be described in the following. Eight oxygen sensor specimens were prepared, with the NOx sensitivity of each these having been measured beforehand by using the method of the second embodiment hereinabove. For each oxygen sensor, the value of boundary current (which flows between the measured gas side electrode and reference gas side electrode when a predetermined fixed voltage is applied across these electrodes) was measured under a condition of supplying a test gas to the measurement electrode through the protective layer, with the NO concentration of the test gas being fixed at 400 ppm and with the test gas being supplied to the sensor (i.e., to the protective layer) at a flow rate of 40 L/minute and a temperature of 500° C.

The measurement results are shown in FIG. 9. Here, the black diamond symbols designate respective plotted values of boundary current of eight oxygen sensor specimens, with these oxygen sensor specimens having respectively different NOx sensitivity values. As can be understood from FIG. 9, it is necessary for the boundary current to be less than 0.2 mA if it is required to attain a NOx sensitivity value of less than 400 ppm.

Hence these results show that an oxygen sensor having good receptivity to NOx can be obtained if the protective layer of the oxygen sensor is configured such that the boundary current is less than 0.2 mA.

What is claimed is:

1. An oxygen sensor adapted for installation in an exhaust system of an internal combustion engine, at a location in said exhaust system downstream from a catalytic converter which cleanses exhaust gas produced from said internal combustion engine, the oxygen sensor comprising
a solid electrolyte which conducts oxygen ions,
a measured gas side electrode and a reference gas side electrode respectively disposed at opposing faces of said solid electrolyte, and
a protective layer which covers said measured gas side electrode while allowing permeation of a measured gas to said measured gas side electrode;
wherein said protective layer is formed to have a thickness that is within a range of thickness values between 270 μm and 500 μm, and is formed to have a value of porosity that is within a range of porosity values between 3% and 7%.

2. An oxygen sensor adapted for installation in an exhaust system of an internal combustion engine, at a location in said exhaust system downstream from a catalytic converter which cleanses exhaust gas produced from said internal combustion engine, the oxygen sensor comprising
a solid electrolyte which conducts oxygen ions,
a measured gas side electrode and a reference gas side electrode respectively disposed at opposing faces of said solid electrolyte, and
a protective layer disposed to cover said measured gas side electrode while allowing permeation of said measured gas to said measured gas side electrode;
wherein said oxygen sensor is configured to have a value of boundary current flowing between said measured gas side electrode and said reference gas side electrode that is within a range of values between 0.1 mA and 0.2 mA, when a predetermined fixed voltage is applied between said measured gas side electrode and said reference gas side electrode under a condition in which a test gas having a concentration of NO gas substantially equal to 400 ppm is supplied to pass through said protective layer to said measured gas side electrode.

3. An oxygen sensor according to claim 2, wherein said gas having a concentration of NO substantially equal to 400 ppm is a mixture of N₂ and NO gases and is supplied at a flow rate of 40 liters/minute.

4. A method of evaluating the receptivity of an oxygen sensor to NOx, wherein said oxygen sensor is adapted for installation in an exhaust system of an internal combustion engine, at a location in said exhaust system downstream from a catalytic converter which cleanses exhaust gas produced from said internal combustion engine, and said oxygen sensor comprises
a solid electrolyte which conducts oxygen ions,
a measured gas side electrode and a reference gas side electrode respectively disposed at opposing faces of said solid electrolyte, and
a protective layer disposed to cover said measured gas side electrode while allowing permeation of a measured gas to said measured gas side electrode;
the method comprising:
supplying to said oxygen sensor, as said measured gas, a mixture of a combustible gas at a concentration of equal to or less than 1000 ppm and NO gas, while successively varying a concentration of said NO gas in said test gas;
measuring respective values of output voltage produced between said measured gas side electrode and said reference gas side electrode, corresponding to successive values of said concentration of NO gas, and detecting when said output voltage attains a predetermined voltage; and
evaluating said receptivity of the oxygen sensor to NOx, based on a value of said concentration of NO gas at which said output voltage attains said predetermined voltage.

5. A method according to claim 4, wherein said predetermined voltage is fixed at a value within a range between 0.50 V and 0.65 V.

6. A method according to claim 4, wherein said predetermined voltage is fixed at a value substantially equal to 0.60 V.

7. A method according to claim 4, wherein a flow rate of said test gas is made higher than 30 liters/minute.

8. A method according to claim 4 wherein said test gas includes N₂ gas and wherein when said concentration of NO in said test gas is altered, a concentration of said N₂ gas in said test gas is altered correspondingly, for maintaining a constant rate of flow of said test gas to said oxygen sensor.
